(19) United States
(12) Patent Application Publication
(10) Pub. No.: US 2013/0087970 A1
(43) Pub. Date: Apr. 11, 2013

(54) METHODS, APPARATUS AND SYSTEMS FOR ENABLING A PLURALITY OF GAMES OF CHANCE, VENDED AND/OR SOLD VIA A NETWORK OF ON-LINE POINT OF SALE TERMINALS, TO BE PLAYED SUBSTANTIALLY SIMULTANEOUSLY UTILIZING A SINGLE SYMBOL MATRIX, WHERE AT LEAST TWO OF THE PLURALITY OF GAMES ARE PLAYED UTILIZING DIFFERING SETS OF RULES

(71) Applicant: Joseph J. Kaliko, Greenwich, CT (US)

(72) Inventor: Joseph J. Kaliko, Greenwich, CT (US)

(21) Appl. No.: 13/646,866

(22) Filed: Oct. 8, 2012

Related U.S. Application Data
(60) Provisional application No. 61/545,326, filed on Oct. 10, 2011.

(51) Int. Cl. A63F 9/00; G06Q 20/00

(52) U.S. Cl. 273/138.1; 705/16

(57) ABSTRACT

A plurality of games of chance, vended and/or sold via a network of on-line point of sale terminals, may be played substantially simultaneously using a single symbol matrix even where at least two of the plurality of games are played according to differing sets of rules, by using randomly drawn elements of the single symbol matrix to advance the play of the individual games until one of them is completed; followed by, according to one embodiment of the invention, continuing to randomly draw elements, if necessary, according to a predefined “parallel play” rule set that takes into account the aforementioned differing sets of rules.

### CROSS REFERENCE TO RELATED APPLICATIONS

The present application is a non provisional of U.S. Ser. No. 61/545,326, filed on Oct. 10, 2011, the contents of which are incorporated herein by reference.

### BACKGROUND OF THE INVENTION

1. Field of the Invention

The invention relates generally to games of chance such as, for example, Keno, Bingo, traditional draw lottery games and the like. Such games require the definition of a symbol universe or “matrix” (for example, the numbers 1-75 in a traditional Bingo game), from which a subset of symbols (for example, numbers, letters or other characters), are drawn, until a particular game is completed according to a predefined set of rules (such as when a “full board” is achieved in a game of Bingo, or where five numbers have been drawn from a predefined pool of numbers in a traditional 5 number draw lottery game).

2. Description of the Prior Art

It is well known by those skilled in the art to utilize a network of on-line point of sale terminals to vend and/or sell lottery tickets in jurisdictions where such gaming is permitted.

For example, traditional lottery draw games have been sold for decades at convenience stores, supermarkets and more generally via a group (or groups) of lottery retailers using such terminals in accordance with the rules and regulations of a gaming authority, such as a state, tribal or provincial lottery board or commission.

Typically a ticket is sold for play on a set date, or time of day (for example, where a drawing is held during the day time and another at night on a given day). In places where allowed, a subscription for a ticket (or tickets) having a desired set of numbers, may be sold and the numbers chosen would be valid over an extended time period, for example, 26 plays of a given set of numbers over a 26 week period. Such a subscription would allow a player to participate in a set of drawings without having to make multiple ticket purchases.

Typically, according to the prior art, the ticket for a particular game is vended and/or sold at one of the on-line terminals in the network; the game is played at the specified time; and the player either wins a prize according to the game rules or loses the game.

Sometimes a form of “extended play” is permitted, as where a “losing ticket” is entered into a drawing held at another date and time; or even entered for play in a completely different game held at another time or even another place.

What is not presently known in the art is the opportunity for a player to play a plurality of games of chance, vended and/or sold via a network of on-line point of sale terminals, to be played substantially simultaneously utilizing a single symbol matrix, where at least two of the plurality of games are played utilize differing rule sets.

In view of the fact that lotteries are constantly trying to provide their players with new and exciting gaming experiences to maintain player loyalty and increase revenue, it is desirable to provide players with a variety of game choices not presently known in the art to keep up their interest in playing games of chance.

It is further desirable to be able to provide players with a variety of gaming experiences, such as extended play games; games of chance that are in some sense “dynamic” by providing entertainment and/or even player participation opportunity in real time as the game progresses; as well as “static” games that require nothing other than verifying ones ticket is a winning ticket at game completion.

Desirable still would be to provide the ability to provide a player with the opportunity to play a plurality of games of chance, substantially simultaneously, providing a form of extended play gaming experience and even a combination of static and dynamic games played, again, substantially simultaneously.

Further still, it is desirable to provide a player with the opportunity to play a plurality of games of chance, substantially simultaneously, particularly where 2 or more of the plurality of games is played using different sets of rules.

### SUMMARY OF THE INVENTION

Accordingly, it is a principal object of the invention to provide a player the opportunity to play a plurality of games of chance, vended and/or sold via a network of on-line point of sale terminals, substantially simultaneously utilizing a single symbol matrix, where at least two of the plurality of games are played utilizing differing rule sets.

It is a further object of the invention to enable lotteries to provide their players with a new and exciting gaming experiences by enabling the player to engage in a form of an extended play gaming experience that even allows for a combination of static and dynamic games to be played substantially simultaneously.

Furthermore, it is an object of the invention to provide a player with the opportunity to play a plurality of games of chance, substantially simultaneously, particularly where 2 or more of the plurality of games is played using different sets of rules.

Further still, it is an object of the invention to enable lotteries to maintain player interest in their games and increase revenues by providing the types of games that are contemplated by the aforestated objects of the invention.

Yet another object of the invention is to provide lotteries with methods, apparatus and systems for diversifying the gaming opportunities and gaming enjoyment for their players utilizing existing lottery infrastructure, like on-line point of sale gaming terminals already in place, without having to suffer significant capital expenditures to support the new and diversified gaming opportunities.

Further objects of the invention include: (a) being able to use a lottery's existing infrastructure and sales network to sell a type of game never offered before to the public; without incurring significant capital expense to upgrade of change the network; (b) allowing players at any time before a game begins, to play 2 or more different “types” of games; more generally 2 or more games played according to different rules, at substantially the same time.

According to the invention, methods, apparatus and systems are provided for enabling a plurality of games of chance to be played substantially simultaneously, even though 2 or more of the games have different rules of play and/or possibly be of different “game types” (to be described in detail hereinafter). An illustrative example of suitable for implementing the present invention are well known networked on-line point of sale terminal systems presently employed by many states to support lottery sales.

According to an illustrative embodiment of the invention, a method is provided comprising the steps of: (a) enabling a plurality of games of chance, at least two of which have different rules of play, to be sold via a networked point of sale terminal; and (b) playing said plurality of games of chance substantially simultaneously using a single symbol set.

Further, according to the method of the illustrative embodiment of the invention, the plurality of games of chance are sold at substantially the same time; and/or are sold on a single ticket dispensed by the networked point of sale terminal. Other embodiments of the invention allow different games of chance to be purchased from different terminals (or even from different geographic areas), via terminals in the network, in advance of the time a plurality of games are played substantially simultaneously utilizing a single symbol matrix for at least two of the plurality of games to be played.

Yet another illustrative embodiment of the invention contemplates a method for enabling a plurality of games of chance, vended and/or sold via a network of on-line point of sale terminals, to be played substantially simultaneously using a single symbol matrix, where at least two of said plurality of games are played according to differing sets of rules, comprising the step of: (a) determining the number of elements x in a first symbol matrix required to play at least a first one of said plurality of games; (b) determining the number of elements y in a second symbol matrix required to play at least a second one of said plurality of games; and (c) utilizing the matrix associated with the larger of x and y to play both of said first one and said second one of said plurality of games.

Apparatus and systems for performing the aforestated methods and other methods supported by the teachings herein, are all further contemplated by the instant invention.

The invention features: (a) methods, apparatus and systems that achieve the aforementioned objectives; (b) providing an almost infinite set of game choices for players to choose from, while providing a significant source of new revenue for lotteries; and (c) utilizing on-line terminals to vend and/or sell games that may be played substantially simultaneously as described herein.

The invention also facilitates “multi-dimensional play”. That is, in a “first dimension” a game plays out on it's own, like a normal draw lottery game, and one can passively check for matched numbers to see if they win at any time after the game is completed. In a “second dimension”, a simultaneously enabled game can be played that DOES NOT require matching numbers in the aggregate per se; but rather involves forming a “pattern” like an “X” on a Bingo card, or completing a circle, etc. In yet a “third dimension” of play, the invention simultaneously facilitates player participation and entertainment. For example, in the play of games in which a player participant can fill in a predefined “pattern” (like a traditional Bingo pattern; or even a pattern that if completed spells a slogan or jingle, like “GO YANKEES”), the player can participate and be entertained as the game progresses. Furthermore, such games could support the possibility of tying ad revenue to the game being played for the benefit of the game sponsor (typically a lottery); and perhaps yield the winner prizes other than or in addition to money, like box seats at a baseball game if a sports related jingle is completed.

These and other objects, embodiments and features of the present invention and the manner of obtaining them will become apparent to those skilled in the art, and the invention itself will be best understood by reference to the following detailed description read in conjunction with the accompanying Drawing.

### BRIEF DESCRIPTION OF THE DRAWING

FIG. 1 depicts a set of blank game cards that will be used to illustrate the teachings of the invention, in particular the ability to play a plurality of games of chance having differing rule sets, at substantially the same time, using a single symbol matrix to drive the different games chance.

FIG. 2 depicts the elements of a symbol matrix containing the numbers 1 thru 30, to be used to illustrate how the games depicted in FIG. 1 may be advanced substantially in parallel, utilizing symbols drawn randomly from the illustrative matrix.

### DETAILED DESCRIPTION

As indicated hereinbefore, one aspect of the invention relates to methods, apparatus and systems for enabling a plurality of games of chance to be played substantially simultaneously, even though 2 or more of the games may have different rules and possibly be of different “game types”.

For the purposes of illustrating the principals of the invention, one “game type”, well known to those skilled in the art, is a “match” game such as a traditional draw lottery game. In such a game the object is to have the numbers selected by (or “quick picked” for) the player, match as many of the numbers randomly “drawn” as possible. The player at the end of the game need only identify if one or more of the numbers on his or her lottery ticket match all or a subset of the numbers actually drawn in the lottery game.

Keno is another example of a game that may be played as a “match” game type. The details of Keno will be described hereinafter for the purposes of illustrating, without limitation, the principals of the invention; this following an example of another “game type”.

Another illustrative game type is a “pattern recognition” type game, such as Bingo. In a Bingo game the object is to have the numbers that are randomly drawn form a predefined winning pattern on a game card (or lottery ticket), such as a row, column, diagonal, four corners, an “X”, full board, etc. Bingo, as well as Keno, will be used to illustrate the principals of the invention.

As alluded to hereinabove, two very different and very well known games may be used to illustrate, by way of example, the principals of the invention. The illustrative games are Keno and Bingo, neither of which is meant in any way to limit the spirit and scope of the invention.

Keno originated in China almost 3,000 years ago, though its transformation from casinos to a lottery game is more recent. With over 2% of lottery sales world-wide, Keno has outgrown its niche status. Keno's rise is primarily a result of its success in the United States market which accounts for 73% of Keno sales world-wide. There are numerous game variations, from the size of the matrix of numbers (more generally, symbols), to the complexity of player-entry options to the frequency of draws. An increasingly popular Keno format is to hold frequent draws, for example every five minutes. (SOURCE: The Whole World Lottery Guide). A specific example is the “Quick Draw” Keno game of chance played in New York State.

In that game players select numbers (typically 1 to 10 numbers, sometimes referred to as “spots”) and try to match them with numbers (typically 20) randomly generated from a “symbol universe”. In the New York game the symbol universe is a field (set) of numbers (1 thru 80). The more numbers a player has chosen to match (and indeed matches), the bigger the payout.

Payoffs vary depending on game structure and frequency of drawings. For example, in New York's electronic Keno, matching all 10 numbers selected in a ten spot game pays $100,000. Matching even one number in a one spot game (one of the 20 drawn being your selected number), pays $2. In NY the game is played every 5 minutes. Between games the video screen on which the numbers selected are displayed also displays advertising for other lottery products or potential products and services offered by others.

In sum, according to the illustrative example, a symbol universe (or matrix) for the NY Quick Draw Keno game is comprised of 80 symbol elements (the numbers 1 thru 80), from which 20 symbol elements (in this example, 20 numbers) are randomly drawn. A valid player ticket is vended and/or sold via a networked on-line point of sale terminal after entering a betting slip or letting the terminal “choose” (quick pick) the “spots” to be played.

Turning now to the game of Bingo to further develop the illustrative example of the principals of the invention.

In Bingo and similar games of chance, the basic elements of the game are a gaming board or card (or lottery type ticket with numbers arranged to form a virtual Bingo board or card) and a random number (or symbol) generating device. The gaming board can be a square array of symbols (with the term “symbol” being defined herein to include numbers), usually a 5 by 5 numerical array, with the centermost location being blank or termed a “free space”. The game is generally played with either 75 or 90 numbers. Each column in the array is usually limited to only one-fifth of the numbers, e.g., the first column numbers are taken from the group 1 to 15 in the event 75 numbers are used, and 1 to 18 if 90 numbers are used; the second column numbers are taken from the group 16 to 30 or 19 to 36, and so on. Further, duplicate numbers cannot appear on a gaming card (ticket).

When the game is being played, the game operator specifies a shape or pattern to be formed on the gaming card by randomly generated numbers (or other legal symbols), and then proceeds to call the symbols generated at random (such as, for example, the numbers between 1 and 75, or 1 and 90, etc.). If a symbol called coincides with one on a player's board, the player marks the symbol in some fashion on his board. The object of the game is to be the first player to have a set of randomly called symbols coincide with the marked symbols on the player's board so as to form the specified shape or pattern.

As alluded to hereinbefore, the specified shape or pattern may be an X, T, L, a diagonal line, five symbols horizontally or vertically, a full board and so on. Several of these games, usually between twelve and eighteen, constitute a Bingo program or session which is played during the course of an evening over several hours. The games are played consecutively and essentially without any major interruption except possibly for intermissions.

Now, according to the invention, even though Keno and Bingo are very different games; are different “game types” (“matching” versus “pattern recognition”, respectively); and have different symbol universes or matrices (80 numbers, 1-80 for Keno versus 75 numbers, 1-75 for Bingo), both games may be played substantially simultaneously by following the following illustrative teachings (but by no means the only way) of practicing the invention.

When a prospective player wants to play both games at once, he or she would (according to this one example) fund each game when making their purchase. So, for example, if the cost of each game played is $1, the request to play both Keno and Bingo together would cost $2 ($1 per gaming), thereby allowing for the funding of separate prize pools according to well know formulas for calculating odds and payouts for both Keno and Bingo.

Next, the larger matrix required to play Keno (in this example 80 numbers), would be used to generate the random numbers that when drawn would be used to develop the Keno field of 20 numbers; while at the same time being used to mark off numbers on the Bingo portion of the ticket sold at , for example, a single on-line networked point of sale terminal. In a variant of this example, two separate terminals could be used. One to vend and/or sell a Bingo ticket; the other a Keno ticket for the same “Draw”. The terminals could be co-located or spread over a wide geographic area.

So long as the numbers 1-75 are drawn during the first 20 numbers generated, both games could end after 20^{th} number is generated. This too is a variable depending on game parallel play rule design.

Going back to the illustrative example, the Keno game would be completed. The Bingo game could be halted. To skew odds since, for example, a full board after 20 “pulls” (numbers generated) is extremely difficult probabilistically, additional “free spaces” could be used when designing the game rules to skew odds; or even further numbers could be generated according to predefined rules, which would only have meaning for the Bingo Game . . . until the networked computer system storing game card Bingo arrays recognizes a predefined pattern . . . or until some predefined maximum total number of pulls is reached.

To take into account the fact that Bingo has only a 75 number universe (matrix); and Keno has an 80 number matrix in this illustrative example; if at any time (before or after the first 20 pulls) any of the 5 numbers 76, 77, 78, 79 or 80 are generated (or pulled) . . . from the single 80 member matrix being used to play both games substantially simultaneously; i.e. if symbols outside the Bingo game universe (matrix) are generated, one could, in one embodiment of the invention, continue to draw from the remaining elements of the single matrix to compensate for the numbers pulled that were outside the smaller Bingo universe.

To be specific, if the first 20 Keno numbers include the numbers 78 and 80 (from the set 76 thru 80), then a predefined “parallel play” set of rules could specify that two more numbers of those remaining in the matrix be pulled to accommodate the Bingo game. These additional 2 numbers would have no affect on the Keno game just completed. Should another one or more of the remaining numbers in the set {76, 77,79} be drawn in the “post Keno play” period; then the process continues until all 20 numbers for the Bingo game have been drawn, with all the numbers then being in the 75 member Bingo subset of the 80 member Keno matrix.

An almost infinite number of variants are possible based on the odds to be specified and types of games to be accommodated.

The end result in following the illustrative process set forth above is to have accomplished the aforestated objects of the invention.

Clearly, those skilled in the art will appreciate that the invention will accommodate the play of many different games, some of which are even the same game type (like, for example a multiplicity of different pattern recognition type games), substantially simultaneously. For example, one could play traditional Bingo as described above (a first pattern recognition type game) using a single 75 member symbol matrix, while playing a second pattern recognition type game substantially simultaneously where the object of the second game is to fill in a pattern that “cheers on” a popular sports team, such as in the baseball context “Let's Go Mets”, etc. If desired, a plurality of different “parallel play” rule sets can be easily devised to accommodate the play of both games of the above described exemplary games (or indeed any number of games), at substantially the same time using the single matrix.

Even a third game, such as for example a traditional lottery draw game, could be played substantially simultaneously with the first two games described above; all using the same single symbol universe (matrix), two matrices to “drive” the 3 games, etc.

As illustrated hereinabove, the invention also contemplates the use of more than one symbol matrix to “drive” a plurality of games substantially played simultaneously, so long as at least one of the plurality of matrices “drives” at least two of the plurality of games.

Still further, the number of different “rule sets” that can be devised for playing games substantially simultaneously is virtually infinite. The “extended draw” rules for allowing the exemplary 80 Keno symbol matrix to drive the exemplary 75 Bingo game (described in detail hereinbefore); could, for example, be modified to accommodate the play of a traditional Keno game and the filling in of a 4 x 4 array pattern (a square block); or a 12 element “circle”, etc. In one embodiment, the “square” of “circle” could be made up of only odd or even numbers, thereby effectively cutting in half the 80 element universe for potential “space fillers”. Rules can be further devised to make all games “playable” with odds offered that are satisfactory to both the game provider (like a lottery) and the player.

In some sense, the invention allows for a novel multidimensional lottery extended play game. One dimension, is a the play of a passive type game, like Keno or a traditional draw lottery; while in a “second dimension”, a pattern recognition type game could be in progress (without player participation . . . just checking the ticket for a win via computer or the newspaper, as is well known in the art, after game completion); while in a “third” dimension the player could be participating in the play of the game as it progresses, for example filling in a pattern, enjoying the participation and entertainment aspects of that game.

The invention described herein also contemplates a point of sale terminal, that allows for the printing of multiple game arrays on a single “game card” (for example, a single ticket; one side or both); via a networked system. The printing could conceivably take place while the terminal is on-line or be could be printed via an off-line terminal at any time after the sale is recorded and the ticket validated in accordance with well known techniques in the lottery industry.

The invention also contemplates enabling a least one of a plurality of games to be played, where the at least one game uses the results of a lottery from a different geographical location from that of the ticket sale (for example, another state lottery), to determine the outcome of the game (or games); and further contemplates simultaneous play of a plurality of games in accord with the teachings of the invention. Thus, a single game card could be used to substantially play, for example, a Connecticut traditional lottery game and a multi-state or regional game, such as Powerball (Trademark), MegaMillions (Trademark) and/or even the say Florida lottery, on a single ticket vended and/or sold by the networked on-line point of sale terminal system.

Attention is now directed to the Drawing to further illustrate the principals of the invention; this time in the context of 3 very different games of chance that can, according to the teachings of the invention, be played substantially in parallel.

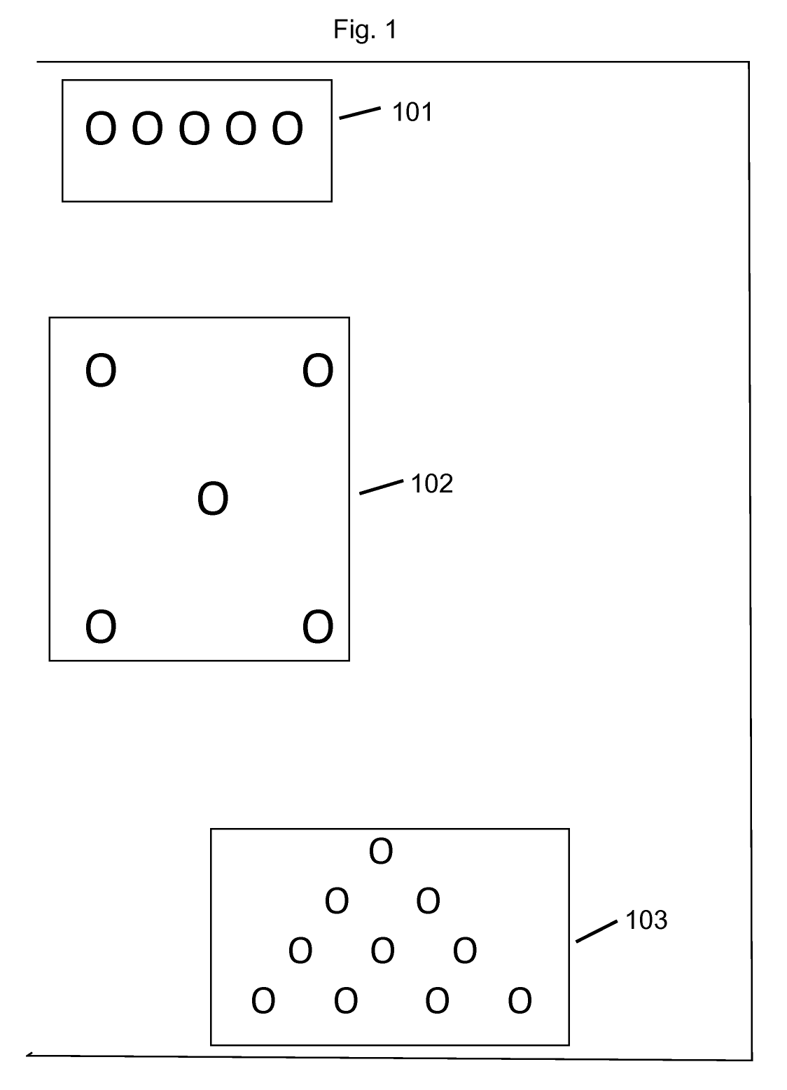

FIG. 1 depicts a set of 3 blank game cards.

Card 101 is comprised of 5 “slots” that the player uses to select the numbers (where the symbols of the play matrix are numbers), of the players choice.

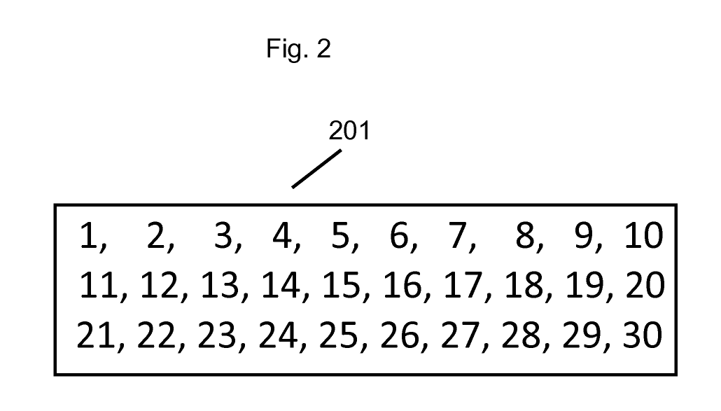

For the sake of illustration only, play matrix 201, shown in FIG. 2, consists of 30 numbers, the integers 1 through 30 inclusive. It is this single set of numbers, drawn randomly over the course of the games being played at substantially the same time, that “drive” or “advance” each game, according to predefined rules. In many games these “elements” are numbered lottery balls in a hopper, randomly drawn.

With reference to Card 101 (also referred to hereinafter as “Game 1”), the rules of the game are (for illustrative purposes only), that the player selects 5 different numbers from the 30 numbers in the play matrix; and “places” these numbers in the 5 slots of Card 101, to represent his choices, ie., hoped for numbers, when a predetermined number of elements (sometimes the aforementioned lottery balls from a hopper) are randomly drawn. These numbers are registered securely with the gaming authority upon, for example, a lottery ticket purchase, as is well known in the art, using, for example, a point of sale terminal which may allow a player to choose his numbers or be provided with a “quick pick” by the system.

For the sake of illustration only, let it be assumed that the first 5 numbers and only the first five numbers drawn, will determine the outcome of game 1. Typically if the 5 numbers drawn match those chosen by the player, the prize is large. Matching 4 of the 5 numbers yields a smaller prize; and even matching 3 of the numbers, according to some rule sets, produces a prize, albeit smaller than if 4 or 5 numbers were matched.

Game 1 is an example of what has been referred to herein as a “static” game. The player need do nothing but compare the numbers drawn randomly with his picks.

Referring again to FIG. 1, this time to illustrative game Card 102, it may be observed that the “game card” for playing “Game 2”, looks like the number “five” on a dice cube. Like in Game 1, the player may choose 5 different numbers from the 30 numbers in the play matrix; and “place” these numbers in the 5 slots of Card 102, to represent his choices, ie., the hoped for numbers, when a predetermined number of elements are randomly drawn. This is done completely independent (according to this illustrative embodiment of the invention), of the numbers chosen for game 1. So for example, the numbers chosen for Game 1 could be the set [3,7,24,26 and 30]; while the numbers for Game 2, being played substantially in parallel could be the exact same 5 numbers, of, for example, the set [1,7,23,26 and 29], etc.

The point is, the numbers may be selected independently for Games 1 and 2; and for Game 3 as well, to be described hereinafter, as another exemplary game for illustrating the principals of the invention.

The object in Game 2 is to develop a winning “pattern”. For example, the rules of Game 2 could specify one prize if all player selected numbers on a diagonal (either one) are drawn. A larger prize could be offered if player selected numbers in the “four corners” are drawn. An even larger prize could be awarded if there is a five number match, effectively creating an “X” pattern on the play card.

Game 2 is an example of what has been referred to herein as a “pattern recognition” game. The pattern made using the drawn numbers determines the payout, if any. This provides an entertainment component to the game as the player can be involved watching (or hoping for) a particular pattern to develop.

For the sake of illustration only, let it be assumed that the first 6 numbers, from the illustrative set of 30 numbers, will determine the outcome of Game 2. These will include the first 5 numbers drawn, driving Game 1 and Game 2 in parallel; and the sixth “pull” having relevance only to Game 2. Of course, these rules may be varied to increase or reduce the level of difficulty of achieving a game's object; and/or modulating payout odds.

Finally, FIG. 1, depicts Card 103, referred to herein as a “bowling pin” arrangement card.

According to the rules of this illustrative Game 3, the player selects 10 of the thirty possible elements of the exemplary matrix shown in FIG. 2; again, with no duplicates on any one game card allowed; but totally independent of the numbers chosen for Game 1 and Game 2 (or other games of any type allowed); assuming the player has elected to play, according to the illustrative example, all three games.

After these 10 numbers are selected and registered with the gaming authority (again, for example, via well know point of sale terminals, via well known subscription sales procedures, etc.), Game 3 may be played with the object of getting a “strike” (as in bowling), “knocking down” (filling in from drawn numbers), all 10 player selected numbers.

According to this illustrative embodiment, the first 18 numbers drawn may be used to determine if a “strike” is achieved; and another 5 numbers (for example), could be used to determine if a “spare” is achieved (ie, all ten “pins” being “knocked down” after the failure to make a “strike” within the number of drawn elements allowed according to the illustrative rule set).

As may now fully appreciated, the same illustrative 30 element array can drive Games 1-3 substantially in parallel, giving the player many different paying opportunities; including the “extended play” and pattern recognition/player entertainment content of illustrative Game 3 per se.

Finally, to illustrate actual play, one is invited to fill out game Cards 1, 2 and 3; before reading further. That is selecting 5 numbers between 1 and 30 (no duplicates) for Game 1; selecting independent of what was selected in Game 1, 5 numbers between 1 and 30 for Game 2 (again no duplicates on Card 2 itself); and finally, independent of the numbers chosen for Games 1 and 2, select 10 numbers (without duplicates on Card 3 per se), from the set of 30 numbers in the matrix, for the 10 bowling “pins”.

After this exercise, the reader may compare the following 23 numbers “drawn randomly” to see if he or she has “won”, by getting at least 3 of the first five drawn number for Game 1; by having made a diagonal, “four corners” or “X” for Game 2 (from the first six numbers drawn); or by making a “strike” or “spare” from the first 18 and 23 numbers respectively, randomly drawn from the same 30 element matrix.

To simulate a drawing, the player/reader, may fill in the cards and have someone else “draw” the numbers; or, for illustrative purposes only, may consult the following Table 1, for an exemplary drawing, after filling in his/her game cards; without looking at Table 1 until after the game cards are filled in.

TABLE 1
ALL THREE OF THE ILLUSTRATIVE GAMES ARE OVER

| | “Random” Number | |
|---|---|---|
| “Pull” number | Pulled (Drawn) | Game Completed |
| 1 | 27 | — |
| 2 | 17 | — |
| 3 | 5 | — |
| 4 | 3 | — |
| 5 | 14 | After Pull 5-End Game 1 |
| 6 | 30 | After Pull 6-End Game 2 |
| 7 | 28 | — |
| 8 | 7 | — |
| 9 | 2 | — |
| 10 | 9 | — |
| 11 | 12 | — |
| 12 | 1 | — |
| 13 | 22 | — |
| 14 | 25 | — |
| 15 | 16 | — |
| 16 | 4 | — |
| 17 | 10 | — |
| 18 | 8 | Pull 18-Last Pull to make |
| | | a “Strike” - |
| 19 | 15 | — |
| 20 | 26 | — |
| 21 | 6 | — |
| 22 | 11 | — |
| 23 | 13 | Pull 23-Last Pull to make a |
| | | “Spare”/End Game 3 |

Many variations of the methods, apparatus and systems described hereinabove can be appreciated by those skilled in the art. For example, tickets for different types of games may be vended and/or sold by different terminals in the on-line network at different times; and the games can still be played substantially simultaneously using a single symbol matrix at the time of play.

What has been described in detail hereinabove are methods, apparatus and systems meeting all of the aforestated objectives. As previously indicated, those skilled in the art will recognize that the foregoing description has been presented for the sake of illustration and description only. It is not intended to be exhaustive or to limit the invention to the precise form disclosed, and obviously many modifications and variations are possible in light of the above teaching.

The embodiments and examples set forth herein were presented in order to best explain the principles of the instant invention and its practical application to thereby enable others skilled in the art to best utilize the instant invention in various embodiments and with various modifications as are suited to the particular use contemplated.

It is, therefore, to be understood that the claims appended hereto are intended to cover all such modifications and variations which fall within the true scope and spirit of the invention.

What is claimed is:

1. A method for playing a plurality of games of chance, where at least two of the plurality of games are played according to differing sets of rules, comprising the steps of:
(a) utilizing a single symbol matrix to play said plurality of games of chance; and
(b) randomly drawing elements from said single symbol matrix to advance the play of the individual games in said plurality of games of chance until at least one of said plurality of games of chance is completed.

2. A method as set forth in claim 1 further comprising the step of continuing to randomly draw elements according to predefined parallel play rules, until at least one other of said plurality of games of chance is completed.

3. A method as set forth in claim 1 further comprising the step of vending said plurality of games of chance via a network of on-line point of sale terminals.

4. A method as set forth in claim 1 further comprising the step of playing said plurality of games of chance substantially in parallel.

5. A method as set forth in claim 1 wherein at least one of said plurality of games of chance is a static game of chance.

6. A method as set forth in claim 1 wherein at least one of said plurality of games of chance is an extended play game of chance.

7. A method as set forth in claim 1 wherein at least one of said plurality of games of chance is dynamic, providing entertainment content for the player in real time as the game progresses.

8. A method as set forth in claim 1 that supports multi-dimensional game play.

9. A method as set forth in claim 3 wherein different ones of said plurality of games of chance may be purchased from different terminals in said network, in advance of the time the plurality of games are played substantially in parallel.

10. A method as set forth in claim 9 wherein different ones of said plurality of games of chance may be purchased from terminals that are not co-located geographically.

11. A method for playing a plurality of games of chance substantially in parallel, comprising the steps of:
(a) utilizing different rule sets for playing at least two of said plurality of games of chance; and
(b) advancing the play of at least two of said plurality of games of chance utilizing a single symbol matrix.

12. A method as set forth in claim 11 further comprising the step of selling at least one of said plurality of games via an on-line point of sale terminal.

13. A method as set forth in claim 11 wherein said on line point of sale terminal is part of a network of on line point of sale terminals.

14. A method as set forth in claim 11 wherein said plurality of games of chance include at least one extended play game of chance.

15. A method as set forth in claim 11 wherein said plurality of games of chance include at least one static game of chance.

16. A method as set forth in claim 11 wherein said plurality of games of chance include at least one dynamic game of chance.

17. A method as set forth in claim 11 that supports multi-dimensional game play.

18. A method for enabling a plurality of games of chance to be played substantially simultaneously using a single symbol matrix, where at least two of said plurality of games are played according to differing sets of rules, comprising the step of:
(a) determining the number of elements x in a first symbol matrix required to play at least a first one of said plurality of games of chance;
(b) determining the number of elements y in a second symbol matrix required to play at least a second one of said plurality of games of chance; and
(c) utilizing the matrix associated with the larger of x and y to play both of said first one and said second one of said plurality of games of chance.

19. A method as set forth in claim 18 that supports multidimensional game play, including passive type games, pattern recognition type games and player participation type games.

20. A method as set forth in claim 18 that further comprises the step of utilizing a plurality of symbol matrices to drive said plurality of the games of chance, so long as at least one of the plurality of matrices drives at least two of the plurality of games of chance.
